(19) United States
(12) Patent Application Publication
(10) Pub. No.: US 2005/0169789 A1
(43) Pub. Date: Aug. 4, 2005

(54) Screw compressor

(75) Inventor: Hiroshi Okada, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/044,170

(22) Filed: Jan. 28, 2005

(30) Foreign Application Priority Data
Jan. 30, 2004 (JP) 2004-022985

(51) Int. Cl. H02K 5/16

(52) U.S. Cl. 418/201.1

(57) ABSTRACT

In a screw compressor including a pair of rotors 1 and 2 rotating while meshing with each other and having mutually different outer diameters, an inter-axial pitch C between a shaft of a large diameter rotor 1 and a shaft of a small diameter rotor 2 is smaller than an outer diameter A of the large diameter rotor 1 and is greater than an outer diameter B of the small diameter rotor 2. A ratio of a length of the large diameter rotor 1 in an axial direction to the outer diameter A is 1 or below and a ratio of a length of the small diameter rotor 2 in the axial direction to the outer diameter B is at least 1. Consequently, it becomes possible to improve workability of the rotors while an air leak between the rotors is suppressed.

### BACKGROUND OF THE INVENTION

1. Field of the Invention

This invention relates to a screw compressor for sucking air from the outside and compressing and discharging compressed air

2. Description of the Related Art

In a screw compressor including a pair of rotors having helical tooth grooves meshing with each other, an air leak is likely to occur from a clearance, called a “blow hole”, between the rotors through which a suction side communicates with a discharge side. To suppress an air leak through the blow hole, a screw compressor with a rotor length decreased to a length smaller than outer diameters of male and female rotors has been proposed (refer, for example, to Japanese Unexamined Patent Publication No. 7-12070). When the rotor length is made smaller than the respective rotor outer diameters as in the screw compressor described in this patent reference, however, a meshing quantity of each rotor becomes great and undercuts occur at the distal ends of each rotor. This undercut is likely to occur particularly in the female rotor.

FIG. 7 is a partial sectional view of a tooth top of a female rotor according to the prior art. As shown in FIG. 7, a recess is formed at a portion indicated by X in the sectional profile of the tooth top of the female rotor and an undercut in which a portion thinner than the distal end portion exists is formed. The workability of the rotors is deteriorated when such an undercut exists.

### SUMMARY OF THE INVENTION

In view of the problem described above, the object of the invention is to provide a screw compressor capable of improving workability of rotors while suppressing an air leak between the rotors.

To accomplish the object, the invention provides a screw compressor including a pair of rotors (1, 2) rotating while meshing with each other and having mutually different outer diameters, wherein an inter-axial pitch (C) between a shaft of a large diameter rotor (1) and a shaft of a small diameter rotor (2) is smaller than an outer diameter (A) of the large diameter rotor (1) and is greater than an outer diameter (B) of the small diameter rotor (2). In consequence, the meshing quantity between the rotors (1, 2) becomes smaller, the occurrence of an undercut at the distal end portion of each rotor (1, 2) can be suppressed and workability can be improved. At the same time, an air leak between the rotors (1, 2) can be suppressed.

In the invention, a ratio of a length of the large diameter rotor (1) in an axial direction to the outer diameter (A) is 1 or below and a ratio of a length of the small diameter rotor (2) in the axial direction to the outer diameter (B) is at least 1. When the ratio of the outer diameter (A, B) of each rotor (1, 2) and the length in the axis direction is set in this way and the distance between bearings of the large diameter rotor (1) having a large bearing load, in particular, is decreased, expansion of a clearance due to deflection of the shaft can be decreased. When a ratio of the length, in the axial direction, to the outer diameter (A) of the large diameter rotor (1) is set to 1 or below, air leak can be suppressed and when the ratio of the length in the axial direction to the outer diameter (B) of the small diameter rotor (2) is set to at least 1, workability can be improved.

In the invention, the large diameter rotor (1) is a driving side rotor and the small diameter rotor (2) is a driven side rotor. Therefore, the large diameter rotor (1) is positioned on a driving shaft of a driving source such as a motor and the small diameter rotor (2) swells out from the driving shaft. In this way, a dead space resulting from the driven side rotor not existing on the driving shaft can be reduced.

In the invention, the driving side rotor is a male rotor and the driven side rotor is a female rotor. Because the female rotor, in which torque due to an internal pressure is small, is used as the driven side rotor and the male rotor is used as the driving side rotor, a torque transmission quantity of the gears can be decreased.

Incidentally, reference numerals, inside the parenthesis, for the means described above represent the correspondence to concrete means described in the later-appearing embodiment.

The present invention may be more fully understood from the description of a preferred embodiment of the invention, as set forth below, together with the accompanying drawings.

### BRIEF DESCRIPTION OF THE DRAWINGS

In the drawings:

FIG. 1 is a sectional view of a screw compressor according to an embodiment of the invention;

FIG. 2 is a perspective view of rotors of the screw compressor;

FIG. 3 is a partial sectional view of a tooth top of a female rotor;

FIG. 4 is a graph showing the relation between an outer diameter of the female rotor and an undercut quantity;

FIG. 5 is a graph showing the relation between the outer diameter of the female rotor and an area of a leak portion (blow hole);

FIG. 6 is a partial sectional view of a distal end portion of the female rotor; and

FIG. 7 is a partial sectional view of the screw top of the female rotor according to the prior art technology.

### DESCRIPTION OF THE PREFERRED EMBODIMENTS

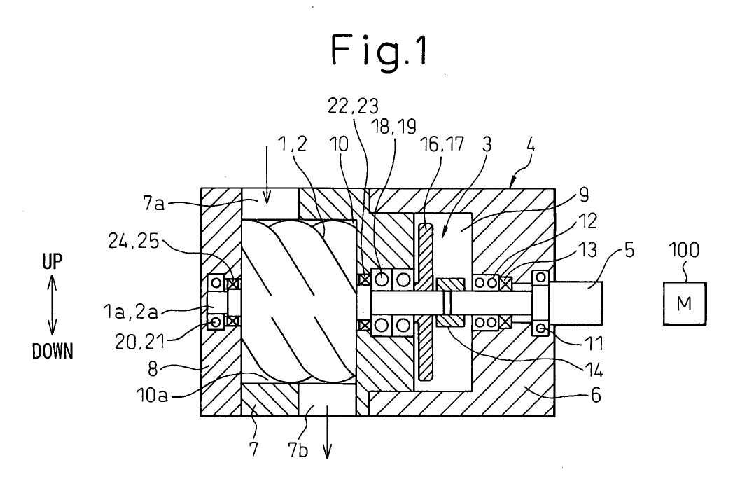

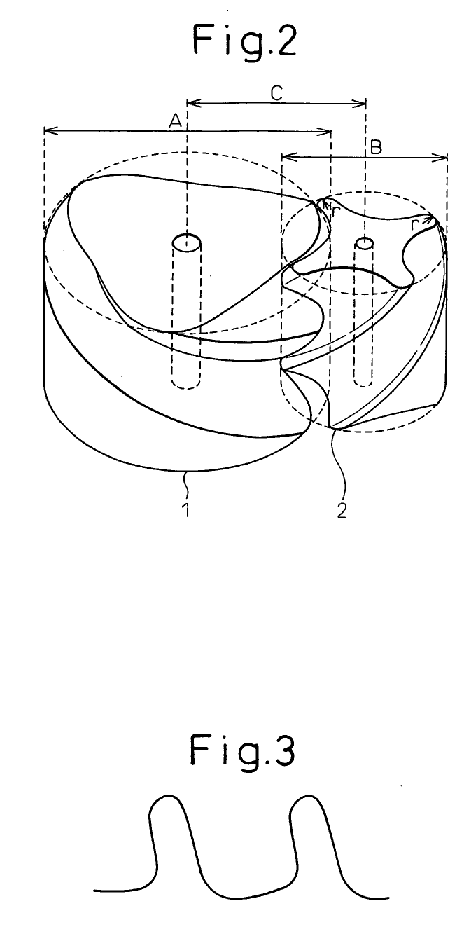

A preferred embodiment of the invention will be hereinafter explained with reference to FIGS. 1 to 6. FIG. 1 is a sectional view of a screw compressor and FIG. 2 is a perspective view of a rotor of the screw compressor.

The screw compressor according to this embodiment includes a male rotor 1 and a female rotor 2 each having a screw shape (refer to FIG. 2), a rotation transmission mechanism 3 for driving and rotating the rotors 1 and 2 by turning force of a driving source, a casing 4 for accommodating the pair of rotors 1 and 2 and the rotation transmission mechanism 3, and an input shaft 5 for receiving the turning force of the driving source. Incidentally, the pair of rotors 1 and 2 is arranged on the back and the front in FIG. 1, respectively.

Each of the male rotor 1 and the female rotor 2 is shaped into a male screw shape having a helical protuberance to mesh with each other. Both male and female rotors 1 and 2 are driven and rotated, through the rotation transmission mechanism 3, by the turning force of a driving source such as an electric motor 100. In this embodiment, the male rotor 1 is on the driving side and the female screw 2, on the driven side. They rotate round rotation axes 1a and 2a, respectively. Therefore, the motor 100 as the driving source is arranged on the extension of the male rotor 1 in the axial direction. These rotors 1 and 2 will be explained elsewhere.

The casing 4 includes a lubrication box 6, a rotor housing 7 and a cover 8 in the order named from the side of the motor 100. The lubrication box 6, the rotor housing 7 and the cover 8 are firmly fixed by fastening means such as bolts (not shown in the drawing). The rotors 1 and 2 and the rotation transmission mechanism 3 are accommodated in the casing 4 while they are separated from one another, and the pair of rotors 1 and 2 is accommodated in the rotor housing 7. The rotation transmission mechanism 3 is accommodated in the lubrication box 6.

The rotation transmission mechanism 3 and a lubricant space 9 for storing a lubricant supplied to the rotation transmission mechanism 3 are formed inside the lubrication box 6. Oil having viscosity equivalent to that of engine oil, for example, can be used as-the lubricant. As the lubricant is splashed onto gears, etc, constituting the rotation transmission mechanism 3, lubrication is conducted.

An input shaft 5 for receiving the turning force from the motor 100 is arranged in the lubrication box 6. A first bearing 11 is arranged in the lubrication box 6 on the side of the motor 100 and the second bearing 12 is arranged on the side of the lubricant space 9. The input shaft 5 is supported by the lubrication box 6 through these bearings 11 and 12. A first oil seal 13 is fitted into an insertion hole formed in the lubrication box 6 into which the input shaft 5 is fitted so as to prevent the lubricant supplied to the first and second bearings 11 and 12 from flowing out.

A rotor chamber 10 accommodating therein the pair of rotors 1 and 2 is formed inside the rotor housing 7. The rotor housing 7 has a suction port 7a for sucking air into the rotor chamber 10 and a discharge port 7b for discharging air out of the rotor chamber 10. The suction port 7a is disposed at an end portion of the rotor housing 7 in the axial direction on the side of the cover 8 and the discharge port 7b is disposed at an end portion of the rotor housing 7 in the axial direction on the side of the lubrication box 6.

A small clearance is formed between the outer peripheral distal ends of the rotors 1 and 2 and the inner wall of the rotor chamber 10 to define a seal structure. A compression chamber 10a for compressing air sucked through the suction port 7a is defined between the rotors 1 and 2 and the inner wall of the rotor chamber 10.

The rotors 1 and 2 are driven and rotated by the rotation transmission mechanism 3 as described above. The rotation transmission mechanism 3 is so constituted as to transmit the rotation of the input shaft 5 to the male rotor rotary shaft 1a and to the female rotor rotary shaft 2a and to synchronously rotate the pair of rotors 1 and 2. The rotation transmission mechanism 3 includes a coupling 14 for transmitting the rotation of the input shaft 5 driven by the motor 100 to the male rotor rotary axis 1a on the same axis and first and second gears 16 and 17 for transmitting the rotation transmitted from this coupling 14 to the male rotary shaft 1a to the female rotor rotary shaft 2a. Incidentally, the first and second gears 16 and 17 are timing gears for synchronously rotating the pair of rotors 1 and 2.

Each of the male rotor rotary shaft 1a and the female rotor rotary shaft 2a is rotatably supported by the rotor housing 7 at one of the ends thereof through third and fourth bearings 18 and 19 and is rotatably supported by the cover 8 at the other end through fifth and sixth bearings 20 and 21.

Second and third oil seals 22 and 23 are respectively fitted to insertion holes formed in the rotor housing 7 into which the rotor rotary shafts 1a and 2a are inserted so as to prevent the lubricant supplied to the third and fourth bearings 18 and 19 from leaking into the rotor chamber 10. Similarly, fourth and fifth oil seals 24 and 25 are fitted to insertion holes formed in the cover 8 into which the rotor rotary shafts 1a and 2a are inserted so as to prevent the grease sealed in fifth and sixth bearings 20 and 21 from leaking into the rotor chamber 10.

Next, the operation of the screw compressor according to this embodiment will be explained.

When the pair of rotors 1 and 2 is synchronously rotated by the rotation transmission mechanism 3, air is sucked into the compression chamber 10a through the suction port 7a formed on the side of the rotor housing 7. At this time, the volume of the compression chamber 10a decreases while the compression chamber 10a moves from the side of the cover 8 towards the lubricant space 9 with the rotation of the pair of rotors 1 and 2. Therefore, air inside the compression chamber 10a is gradually pressurized and compressed and moves towards the lubricant space 9.

When the rotation angle of the pair of rotors 1 and 2 reaches a predetermined angle, the compression chamber 10a reaches the discharge port 7b formed on the side of the lubricant space 9 of the rotor housing 7 and the compression chamber 10a that has so far been sealed is released at the discharge port 7b. In consequence, compressed air inside the compression chamber 10a is discharged from the discharge port 7b.

Next, the rotors 1 and 2 of the screw compressor will be explained in detail with reference to FIGS. 2 to 6.

In this embodiment, the male rotor 1 is the large diameter rotor and the female rotor 2 is the small diameter rotor, and the outer diameter A of the male rotor 1 is greater than the outer diameter B of the female rotor 2 as shown in FIG. 2. The inter-axial pitch C between the shaft of the male rotor 1 and the shaft of the female rotor 2 is smaller than the outer diameter A of the male rotor 1 and is greater than the outer diameter B of the female rotor 2. In other words, the outer diameter A of the male rotor 1, the outer diameter B of the female rotor 2 and the inter-axial pitch C between the shaft of the male rotor 1 and the shaft of the female rotor 2 satisfy the relation A>C>B. In this embodiment, the outer diameter A of the male rotor is 100 mm, the outer diameter B of the female rotor is 60 mm and the inter-axial pitch C between the male rotor 1 and the female rotor 2 is 64 mm by way of example. Furthermore, the ratio of the axial length of the male rotor 1 to the outer diameter A is set to be 1 or below and the ratio of the axial length to the outer diameter B of the female rotor 2 is set to be at least 1.

FIG. 3 is a partial sectional view of the tooth top of the female rotor 2. In the drawing, symbol r represents a radius of curvature of the tooth top of the female rotor 2. No recess is formed at the tooth top of the female rotor 2 according to this embodiment and undercut is not formed, either.

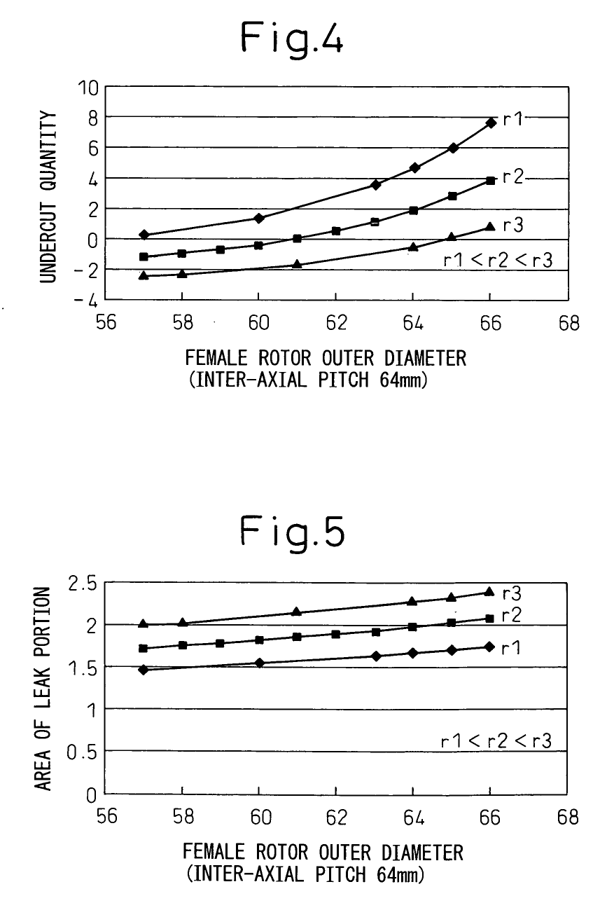

FIG. 4 shows the relation between the outer diameter B of the female rotor 2 and the undercut quantity when the inter-axial pitch C of the rotors 1 and 2 is 64 mm. FIG. 5 shows the relation between the outer diameter B of the female rotor 2 and the area of the leak portion (blow hole) when the inter-axial pitch C between the rotors 1 and 2 is 64 mm. Symbols r1 to r3 in FIGS. 4 and 5 represent the radii of curvature of the tooth tops of the female rotor 2, and r1=2.5 mm, r2=3.0 mm and r3=3.5 mm, satisfying the relation r1<r2<r3. Symbol − (minus) on the ordinate of the graph in FIG. 4 represents the state where undercut does not exist and processing is easy, and symbol + (plus) represents the state where undercut occurs and processing is not easy.

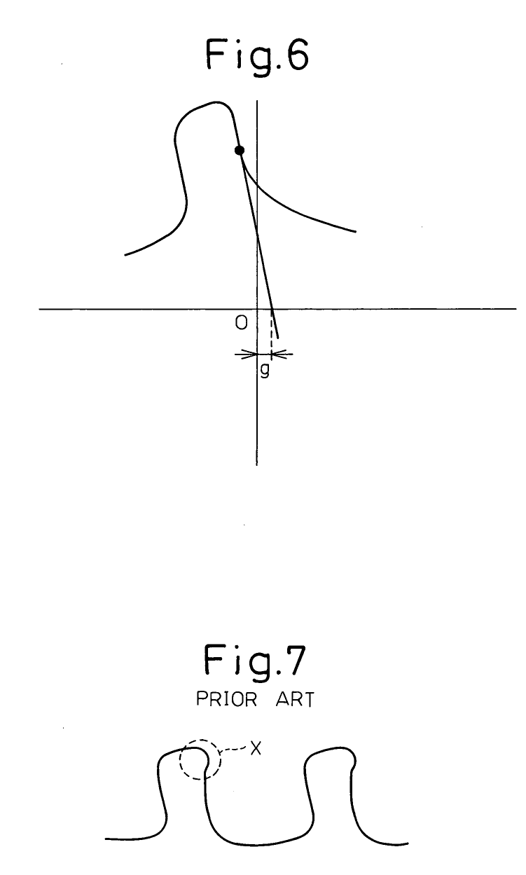

FIG. 6 is a partial sectional view of the distal end portion of the female rotor 2 for explaining the concept of the undercut quantity. As shown in FIG. 6, the distance g between the tangent with respect to the sectional profile of the rotor distal end portion and the rotor center point 0 is set as the undercut quantity.

As shown in FIG. 4, it is believed that the meshing quantity between the rotors 1 and 2 becomes great in an area where the outer diameter B of the female rotor 2 is approximately 64 mm or more, though the relation differs to a certain extent depending on the radii of curvature r1, r2, r3 of the tooth tops of the female rotor, and the rise ratio of the undercut quantity becomes high. Therefore, it can be seen that, when the outer diameter B of the female rotor 2 is smaller than the inter-axial pitch C and the meshing quantity between the rotors 1 and 2 is reduced, the undercut quantity occurring at the distal end of the female rotor 2 can be decreased. It can be seen from FIG. 5 that when the outer diameter B of the female rotor 2 is decreased, the area of the leak portion can be decreased.

When the inter-axial pitch C between the pair of rotors 1 and 2 is smaller than the outer diameter A of the male rotor 1 as the large diameter rotor and is greater than the outer diameter B of the female rotor 2 as the small diameter rotor as in the embodiment described above, the meshing quantity between the rotors 1 and 2 is reduced and the occurrence of undercut at the distal end portion of each rotor 1 and 2 can be suppressed. Consequently, workability can be improved and, at the same time, an air leak between the male rotor 1 and the female rotor 2 can be suppressed.

Expansion of the clearance resulting from deflection of the shafts can be reduced by setting the ratio of the axial length of the outer diameters A and B of the rotors 1 and 2 and by reducing the distance between the bearings of the male rotor 1 having a particularly large load. Furthermore, an air leak can be suppressed by setting the ratio of the axial length to the outer diameter A of the large diameter rotor 1 to 1 or below and workability can be improved by setting the ratio of the axial length with respect to the outer diameter B of the small diameter rotor 2 to at least 1.

The male rotor 1 as the large diameter rotor is arranged on the driving side and the female rotor 2 as the small diameter rotor, on the driven side. Therefore, the large diameter rotor 1 is positioned on the driving shaft of the motor 100 and the small diameter rotor 2 swells out from the driving shaft. Consequently, the volume of the swell-out portion can be reduced and the dead space resulting from the rotor on the driven side not existing on the driving shaft can be decreased.

From the aspect of the construction of the screw, the female rotor 2, for which torque due to the internal pressure becomes small, is used as the rotor as the driven side and the male rotor 1 is used as the rotor on the driving side. In this way, the torque transmission quantity of the gears can be reduced.

In the embodiment described above, the large diameter rotor is the male rotor and the small diameter rotor is the female rotor, but this construction is not restrictive. In other words, the large diameter rotor may be the female rotor and the small diameter rotor may be the male rotor. In such a case, too, it is possible to prevent the occurrence of undercut in each rotor while an air leak between the rotors is suppressed.

While the invention has been described by reference to a specific embodiment chosen for purposes of illustration, it should be apparent that numerous modifications could be made thereto by those skilled in the art without departing from the basic concept and scope of the invention.

1. A screw compressor including a pair of rotors rotating while meshing with each other and having mutually different outer diameters, wherein an inter-axial pitch (C) between a shaft of a large diameter rotor and a shaft of a small diameter rotor is smaller than an outer diameter (A) of said large diameter rotor and is greater than an outer diameter (B) of said small diameter rotor.

2. A screw compressor according to claim 1, wherein a ratio of a length of said large diameter rotor in an axial direction to the outer diameter (A) is 1 or below and a ratio of a length of said small diameter rotor in the axial direction to the outer diameter (B) is at least 1.

3. A screw compressor according to claim 1, wherein said large diameter rotor is a driving side rotor and said small diameter rotor is a driven side rotor.

4. A screw compressor according to claim 3, wherein said driving side rotor is a male rotor and said driven side rotor is a female rotor.
